(19) United States
(12) Patent Application Publication
(10) Pub. No.: US 2005/0212324 A1
(43) Pub. Date: Sep. 29, 2005

(54) Door assembly as well as method for its production

(75) Inventors: Josef Mittermeier, Dorfen (DE); Michael Fischer, Vilsbiburg (DE)

Correspondence Address: SUGHRUE MION, PLLC, 2100 PENNSYLVANIA AVENUE, N.W., SUITE 800, WASHINGTON, DC, 20037, US

(73) Assignee: LISA DRAXLMAIER GMBH

(21) Appl. No.: 11/072,259

(22) Filed: Mar. 7, 2005

(30) Foreign Application Priority Data
Mar. 8, 2004 (DE) 10 2004 011 136.7

(51) Int. Cl. B60J 5/00

(52) U.S. Cl. 296/146.5

(57) ABSTRACT

The invention relates to a door assembly, in particular for use in a motor vehicle, comprising a window frame, a function carrier which can be connected with the window frame, as well as an outer skin arranged on the outside of the function carrier and, if required, on the window frame. The invention further relates to a method for the production of a door assembly in which a function carrier is formed, this function carrier being connected to a window frame and an outer skin is then attached to the function carrier. Finally, the invention relates to a method for the connection of a door assembly to an outer skin.

### FIELD OF THE INVENTION

The invention relates to a door assembly, in particular for use in a motor vehicle, comprising a window frame as well as a function carrier accommodating at least one door component and which can be connected to the window frame. The invention further relates to a method for the production of a door assembly as well as to a method for connecting a door assembly to an outer skin.

### PRIOR ART

Doors, in particular for use in motor vehicles, are usually composed of a door outer sheet metal and a door inner sheet metal, the door outer sheet metal comprising the door panel and, if necessary, also the window frame. The door further has a door inner sheet metal which is, as a rule, fixedly connected to the door outer sheet metal. As a rule, the connection of the outer panel-inner panel is already made on the unpainted body-in-white and, in particular, also prior to mounting the door components. All door components mounted in the door are attached between the door outer sheet metal and the door inner sheet metal. These include e.g. windows as well as window lifter devices, door locks, grips, levers, control devices, sets of lines or such like, as well as possibly provided elements reinforcing the structure, such as crash struts or such like. In connection therewith, it is common practice that these door components are inserted into the door through built-in openings provided in the door inner sheet metals and fastened therein.

Based on the increased requirements regarding both the possibility of dismounting and mounting the door components as well as the weight of the entire vehicle and in particular the vehicle doors, efforts have been made in the past to simplify this complex structure of the doors and to simultaneously reduce the quantity of sheet metal used therein to a minimum.

DE 35 20 975 Al therefore proposed to produce the door for a motor vehicle substantially of a frame-like metal structure, the interspaces of which are integrally filled with a synthetic material. The individual door components are subsequently mounted in this synthetic material before the door is completed by applying a metal outer skin from the outside. However, in this method, the problem has to be overcome that at least parts of the inner panelling must be removed again, in particular in case of a mounting and/or an exchange of door components which are accommodated in the wet region of the door.

### DESCRIPTION OF THE INVENTION

It was therefore an object of the invention to provide a door assembly, a method for the production of a door assembly as well as a method for connecting a door outer skin to the remaining door assembly, which no longer exhibit the problems known from the prior art.

These objects of the invention are solved by the door assembly having the features of claim 1, the method having the features of claim 18, as well as the method having the features of claim 22. Advantageous embodiments of the invention are to be found in the respective dependent claims.

According to a first aspect of the invention, a door assembly is provided which has a window frame and a function carrier to be connected to the window frame. Preferably, all door components are accommodated, in particular integrally inserted, in this function carrier. Finally, an outer skin is applied to the function carrier from the outside and, if required, to the window frame.

The present invention is characterized in that the function carrier, after having been connected to the window frame, substantially represents the complete structure of the door assembly, wherein it can completely be done without using a door inner sheet metal. The door assembly according to the invention allows both a particularly simple mounting and/or replacement of door components as well as the use of particularly light outer skin materials which can particularly be painted prior to their assembly with the remaining door assembly.

The present invention thus provides the possibility to produce a door, in particular for use in a motor vehicle, in a particularly simple and cost-saving manner and, in addition, allows that lighter materials can be used than those commonly used. Thus, the entire vehicle weight can be substantially reduced without the necessity that impairments such as stiffness, form stability, safety or appearance of the door having to be accepted.

In particular, the advantage of the present invention consists in providing a door assembly for a motor vehicle, wherein preferably a door inner sheet metal or a metal frame in the region below the window frame can be completely dispensed with.

The door assembly according to the invention has a modular structure in which preferably all door components can be combined to form one module. The hinges, the lock, the window lifters as well as all parts to be mounted in the wet region of the door and, in addition, preferably crash elements for protection against lateral impact, can preferably be combined to form one integral component part. This modular assembly makes it possible to design the single parts more homogenously and particularly adapted to their respective function.

The invention is not limited thereby to the front and back doors of a motor vehicle or the type of their closing motion. Rather, also rear flaps or lateral sliding doors may also have the door assembly of the invention.

In a preferred embodiment of the present invention, the outer skin of the door assembly according to the invention does not, substantially, assume a structure-bearing function. This provides the possibility that outer skin materials are used which are used for reasons of aerodynamics of the vehicle only and must therefore only provide thickness and stiffness sufficient to ensure its own form stability.

In a preferred embodiment of the present invention, the outer skin which is finally applied to the remaining door assembly consists of a light metal or a synthetic material. In a particularly preferred embodiment, this synthetic material is a fiber composite which can be produced preferably by means of injection moulding with thermoplastic materials, or by means of a resin injection process of duroplastic materials which is sufficiently known to the skilled person. A door assembly is created thereby which allows a weight reduction to be obtained, in particular by a reduction of the comparably heavy metal proportion to a minimum, without impairing the optical appearance of the door or its safety standard.

In a further preferred embodiment of the invention, the door assembly does not have a door inner sheet metal. A door assembly is thereby created in which the quantity of parts used is reduced to a minimum and, in addition, the assembly is particularly advantageously simplified. In a further preferred embodiment of the invention, the function carrier substantially consists of a synthetic material. In a particularly preferred embodiment of the invention, this synthetic material is reinforced at least in partial regions.

In a still more preferred embodiment, the function carrier is produced in a cast moulding process, in particular in the injection moulding process or the injection embossing process. Alternatively thereto, a resin injection process can also be used. A function carrier is provided thereby which can be produced in a particularly simple manner and which opens a particularly broad spectrum of forming possibilities in processes which are particularly well controllable.

In a particularly preferred embodiment of the door assembly of the invention, the function carrier has a thermoplastic matrix which is preferably fiber-reinforced at least in parts. The LFT (long fiber thermoplast) process is preferably used which is known to the skilled person, in which synthetic material granulates are mixed with glass rovings and then pressed with fiberglass cloth, if required. When the resin injection process is applied, the use of duroplastic materials is preferred.

A material is hereby preferably used, the forming and form stability characteristics of which are particularly preferred for the application according to the invention and which can be adapted to nearly each material property required, i.e. in particular by selection of quantity and types of the fiber-reinforcing material.

In a further, especially preferred embodiment of the invention, the function carrier contains reinforcing elements in particular in regions which are subjected to greater load. In a particularly preferred embodiment of the invention, these reinforcement elements are long-fiber-reinforced PA, PP, PET or PE, in particular liners reinforced by endless fibers. A permanent form stability and stiffness of the synthetic material frame is ensured by such a selection of materials also in case of high load, in particular in crash situations or in regions of the door assembly which are particularly subject to wear.

In an alternatively preferred embodiment of the invention, the function carrier substantially consists of light metal, preferably substantially of aluminium. In a particularly preferred embodiment, the function carrier is produced in the diecasting process. A function carrier is thereby provided which, as compared with the usual steel constructions, allows a significant weight reduction to be achieved and additionally ensures the above-indicated advantages regarding mounting or replacement of function carriers as well as forming possibilities.

In a further preferred embodiment of the door assembly of the invention, the function carrier is covered towards the interior of the vehicle at least partially by one or several door inner sheet panellings. This provides the possibility that parts of the function carrier completely replace the door inner sheet pannelling, on the one hand, and, on the other hand, that further door components, e.g. grips, shift levers, actuating elements and such like or decor elements are mounted on the function carrier which can preferably be easily removed. A door assembly is created which, despite its particularly simple structure, nevertheless provides any desired possibility of freely designing the appearance and the functioning of the door side which faces the interior of the vehicle.

In a further preferred embodiment of the invention, the function carrier of the door assembly according to the invention is designed such that it divides the vehicle door into a wet region and a dry region. This is preferred since certain door components, e.g. window lifters or such like, must be mounted in the wet region, and other door components, e.g. electronic or electric components as well as actuating and servo elements or loudspeakers or the like must, in principle, be protected against moisture and are therefore mounted in the dry region.

In connection therewith, a preferred embodiment of the invention consists in that the function carrier is designed such that a reliable separation of wet region and dry region is already ensured when the door assembly according to the invention is mounted, without additional sealing measures or covers being required.

In a further preferred embodiment of the invention, the connection of function carrier and window frame is performed by screwing and/or riveting and/or welding and/or gluing. Alternatively, it is possible to produce the window frame as one piece with the function carrier.

In a further preferred embodiment of the invention, the window frame is produced of a metal, e.g. of steel or aluminium. Alternatively, a synthetic material, preferably a fiber-reinforced synthetic material, could also be used. An injection moulding process is possible for thermoplastic materials, while a resin injection process can be used for duroplastic materials.

In a particularly preferred embodiment of the invention, the window frame has at least one connection element projecting in the direction of the function carrier, which element especially advantageously serving to support the stiffness of the construction.

These connection elements are mounted in a particularly preferred manner in the front and/or rear region of the window frame and can thus serve as reinforcement elements for the hinge and/or locking region of the function carrier. A door assembly is thereby created which ensures a particularly advantageous stiffness for the safety of the vehicle, while its structure is especially simple and its assembly is also particularly simple.

According to a second aspect of the invention, a method for the production of a door assembly is provided containing the steps of forming a function carrier, connecting the function carrier with a window frame, mounting one or several door components in the function carrier, if required, and the subsequent application of an outer skin, preferably of an outer panel, on the function carrier.

A method is thereby provided which allows a particularly simple door assembly wherein the door components are preferably integrally connected to the function carrier and are freely accessible both from the inside and from the outside of the door assembly until the final application of the outer skin. In addition, the possibility of replacing damaged outer skin parts or parts which exhibit paint inaccuracies is provided, without the risk of changing or weakening the entire door assembly when a replacement is carried out.

In addition, the door systems can be mounted when a motor vehicle is assembled without the outer skin having been already applied. Thus, a method is provided in which the door assemblies as a whole do not need to participate in a possible removal from assembly, perhaps due to drying times, in particular, after reworking the paint, but only the outer skin itself. The mounting operation of a motor vehicle is thus especially advantageously supported and simplified.

In a further preferred embodiment of the method according to the invention, painting of the outer skin or any other colouring and surface treatment is carried out already prior to connecting the outer skin to the remaining door assembly. As was already stated above, the replacement of damaged components is thereby simplified in a particularly advantageous manner. It is further possible that the premounting of the door assembly can be performed nearly completely externally from the plant responsible for the assembly of the vehicle, and the automotive manufacturer only applies the outer skin in a final working step. A further advantage results in case repair or maintenance is required. The outer skin can easily be removed and, therefore, the access to door components displaced beneath and which must be repaired or replaced is easy.

In a preferred embodiment of the method according to the invention, the forming of the function carrier is carried out in a casting method. In a particularly preferred embodiment, this casting method is an injection moulding process or an injection embossing process. Alternatively thereto, a resin injection process can be used. In an exceptionally preferred embodiment of the method, the forming of the function carrier is carried out together with the arrangement of individual, preferably all, door components to the function carrier. A method is thereby provided in which the number of required working steps was reduced to a minimum in a particularly advantageous manner.

According to a third aspect of the present invention, a method for connecting a door assembly is provided, in which a function carrier is externally connected to an outer skin and this connection is performed by means of laterally attached embracing-edge connections.

A method is thereby provided, in which the connection of outer skin and remaining door assembly is especially simple, reliable and reversible, however, no limitations need to be simultaneously accepted regarding safety and optical appearance of the door assembly.

In a preferred embodiment of the method, the method is applied for connecting the above-described door assembly to an outer skin, preferably an outer panel. In a further preferred embodiment of the method according to the invention, the connection is performed via embracing edges which are attached at least partially to the sides of the outer skin which engage with corresponding recesses of the function carrier frame.

It is therein not necessary that each side of the outer skin has such an embracing edge. Rather, it is an embodiment of the door assembly that at least one side, preferably the side of the door assembly facing the A column of a vehicle, has an embracing edge of the outer skin, while the side opposite to this side, e.g. the side of the outer skin facing the B column, does not have an embracing edge. In this case it is advantageous if the last-mentioned side can engage with a corresponding embracing region of the function carrier.

Opposite groove and tongue joints between function carrier and outer skin are thereby provided in a particularly preferred manner. A connection is created which can be produced by an especially low number of working steps and which is cost-saving, without limiting safety in any manner whatsoever and is nevertheless easily detachable.

In a further preferred embodiment of the connection method of the invention, additional sealing elements, preferably rubber lips, are arranged preferably continuously over the entire groove and tongue joint between function carrier and outer skin.

This allows an increase in safety and density of the connection by especially simple means and for a long time. Further, based on the variety of forms of such sealing elements which can be especially simply produced, the use of rubber lips also offers the possibility to also cover edge regions and/or adjacent regions of these connection regions preferably by the same sealing element.

A connection is created which is particularly simple and reliable and which reliably protects the workpieces used during assembly, in particular paint on the outer skin.

### SHORT DESCRIPTION OF THE DRAWINGS

In the following, the present invention is explained in detail by means of FIGS. 1 to 7, these Figures showing only exemplary embodiments of the device according to the invention. However, the Figures are not suited to limit the general basic idea of the invention in any manner whatsoever.

FIG. 1a shows a cross-sectional view of a first embodiment of the door assembly according to the invention,

FIG. 1b shows a cross-sectional view of a second embodiment of the door assembly according to the invention,

FIG. 2 shows a perspective view of a function carrier according to the invention,

FIG. 3 shows a side view on a window frame according to the invention,

FIG. 4 shows a diagrammatic view of the application of the outer skin to the remaining door assembly,

FIG. 5 shows a side view onto the door assembly according to the invention in which the outer skin was removed,

FIG. 6 shows a plane view onto the individually shown reinforcement elements of FIG. 5,

FIG. 7 shows a diagrammatic plane view onto an outer skin,

FIG. 7a shows an enlarged cross-sectional view of the connection of outer skin and function carrier on the left side of FIG. 7,

FIG. 7b shows an enlarged cross-sectional view of the connection of outer skin and function carrier on the right side of FIG. 7.

### PATHS TO REALIZATION OF THE INVENTION

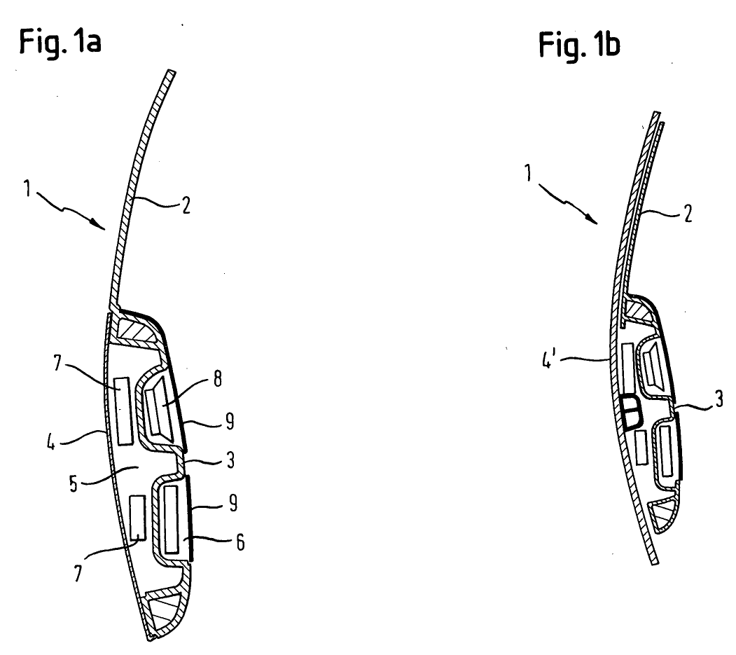

FIG. 1a shows a cross-sectional view of a first embodiment of the door assembly 1 according to the invention. The door assembly 1 has a window frame 2 and a function carrier 3 connected to this window frame 2. An outer skin 4 is applied to this function carrier 3 which only extends in this case to the bottom edge of the window frame 2. The function carrier 3 divides the door assembly 1 below the window frame 2 into a wet region 5 and one or several dry regions 6. Door components 7, in particular actuation elements for the window lifter mechanism, are mounted in the wet region 5 which must normally not be particularly protected against the access of moisture. Contrary thereto, the door components 8 are arranged in the dry region 6 of the door assembly which must particularly be protected against moisture, e.g. loudspeakers or other electric or electronic devices. Additional inner panellings 9 are attached towards the interior of the vehicle on the function carrier 3, which may, for example, contribute to the cover of the door components 8 or to improve the optical appearance of the door assembly 1.

A second embodiment of a door assembly 1 according to the invention is represented in FIG. 1b, which is substantially composed of the same components 2, 3, 4. The window frame 2 and the function carrier 3 are substantially designed in a similar manner, as is shown in FIG. 1a. The greatest difference between the embodiments according to FIG. 1a and FIG. 1b consists in that the outer skin 4′ is applied over the entire height of the door assembly 1 according to the invention, i.e. also to the front side of the window frame 2.

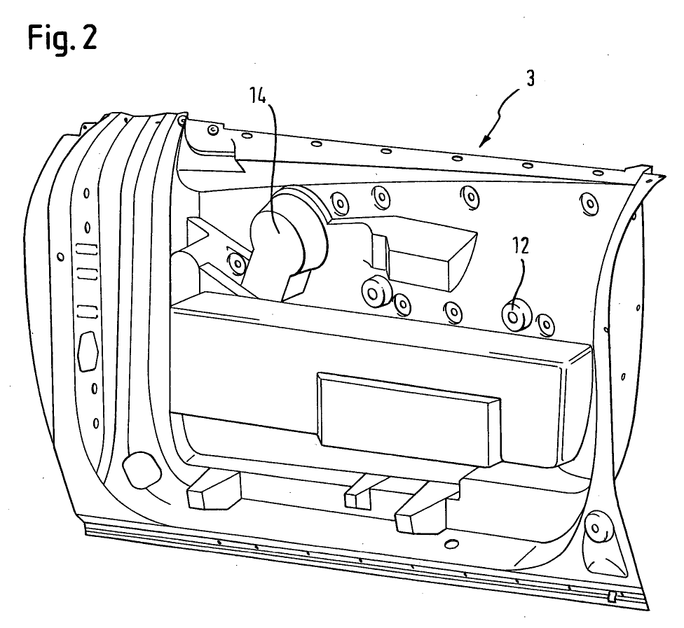

FIG. 2 shows a diagrammatic view of a function carrier 3 of the invention. The function carrier 3 shows the rear sides of recesses for various door components, e.g. of a window lifter 12 or a loudspeaker 14.

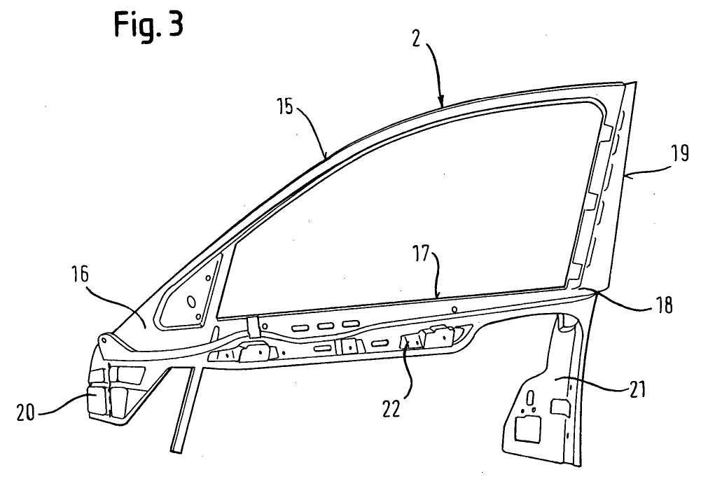

FIG. 3 shows a side view of a window frame 2 according to the invention. At its roof edge 15, this window frame consists of a steel or aluminium hollow profile which is provided with window blind rails formed thereon, if required. In the cross-sectional region 16 of roof edge 15 and bottom window edge 17 and at the intersection point 18 of the lower window frame 17 and the lateral end edge 19 facing the B column of the vehicle (not shown), one welding connection each is provided having reinforcements 20, 21 which are shown as dot-dash lines, through which a connection to the function carrier (not shown) is possible in an especially reliable and form-stable manner. In addition, the bottom edge 17 of the window frame 2 preferably has reinforcements 22 for the window shaft, preferably made of aluminium sheet metal.

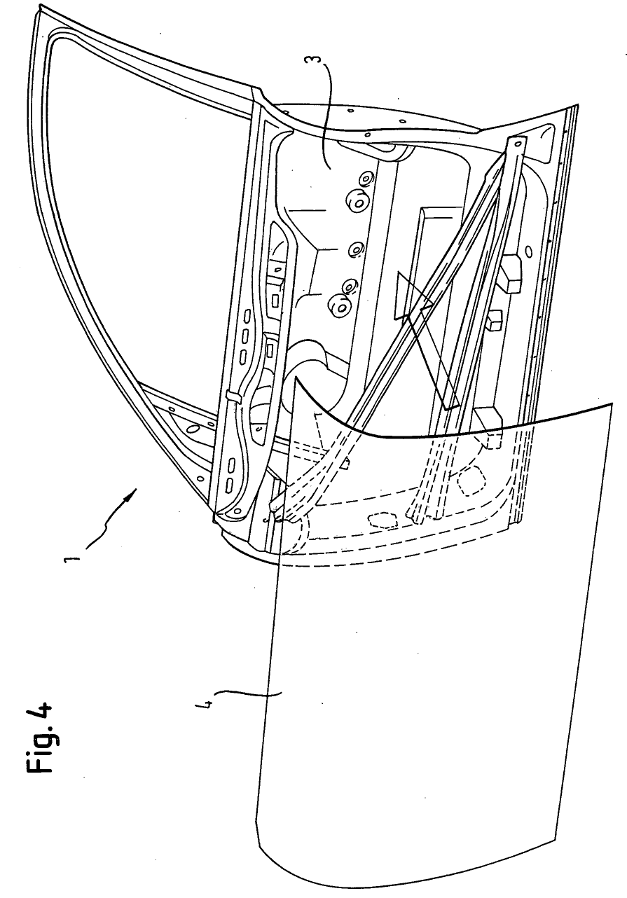

FIG. 4 shows a door assembly 1 according to the invention in which the outer skin 4 is applied to the function carrier 3, which is equipped with all door components, from the outside.

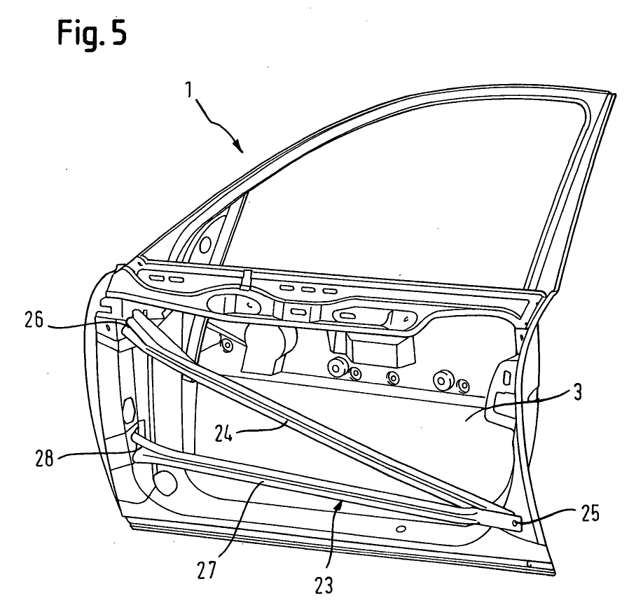

FIG. 5 shows a door assembly 1 of the invention in which the outer skin is not shown. Additional reinforcement elements are mounted in the function carrier 3 which together form a crash strut 23. The crash strut 23 consists of a structure running substantially diagonally along the entire function carrier 3. A branch 27 is additionally attached to this diagonal structure 24 which is connected to the function carrier 3 at particularly strong connecting points 25, 26, which branch being attached to the function carrier 3 at point 28.

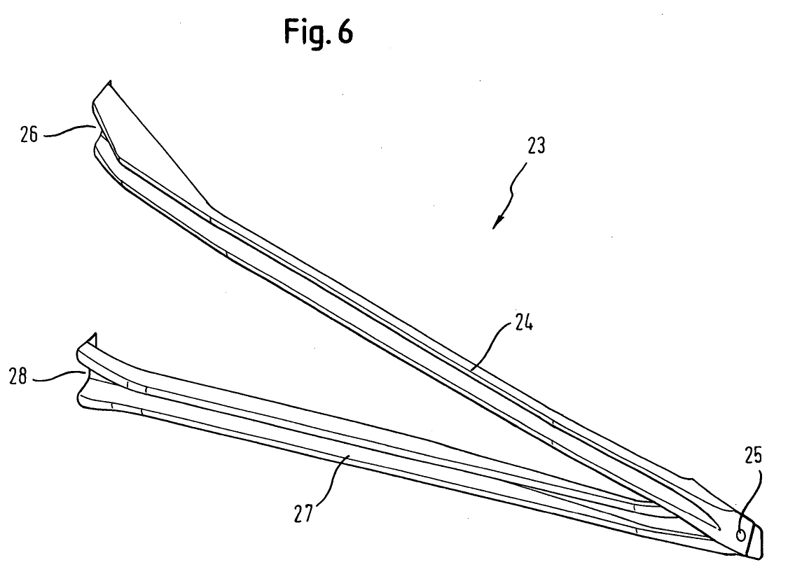

The crash strut 23 is individually shown in FIG. 6. Therein, the diagonal element 24 can be recognized which is connected to the function carrier (not shown) at the connecting points 25, 26, as well as the branch 27 which connects the diagonal strut 24 to the function carrier (not shown) around the connecting point 28.

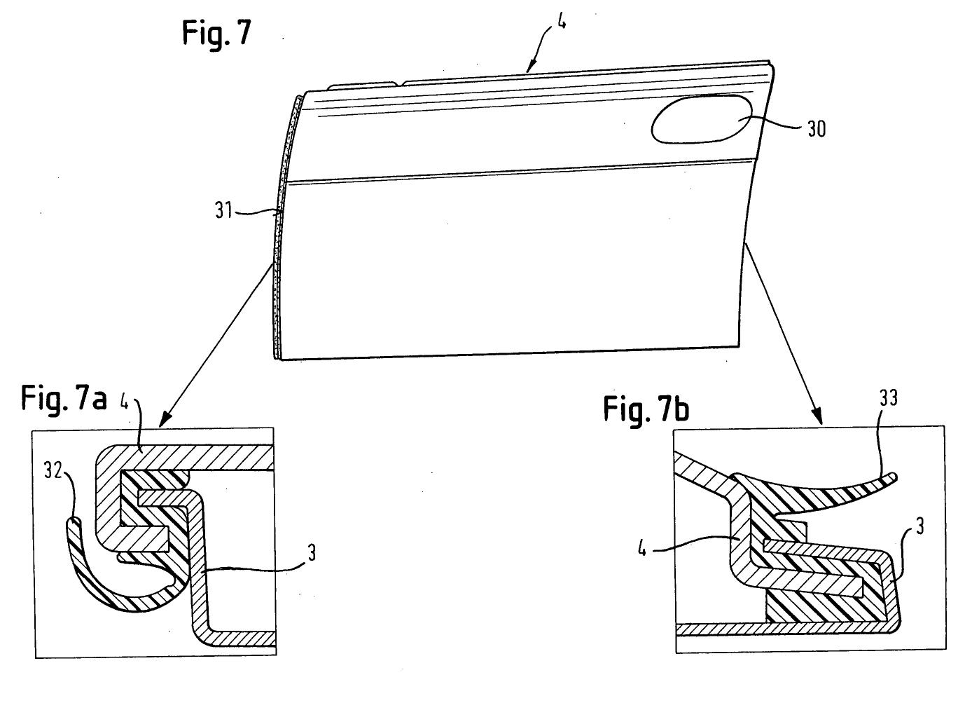

FIG. 7 shows an outer panel 4 of the door assembly of the invention (not shown). The outer panel 4 has a substantially oval opening 30 for the receipt of a door handle and a door handle recess. In addition, the outer panel 4 has a continuous bend edge at its front edge 31.

FIG. 7a shows an enlarged cross-sectional view of the bend edge 31 of the outer panel 4 which is arranged embracing an edge region of the function carrier 3. The connection of outer panel 4 and function carrier 3 is performed quasi as a groove-tongue joint. This groove-tongue joint is additionally fixed by a sealing lip 32 which is designed such that it additionally grips around the outer region of the bend edge 31.

FIG. 7b is an enlarged cross-sectional view of the connection region of outer skin 4 and function carrier 3 at the side of the outer panel 4 opposite to side 31. The function carrier 3 has a bend edge on this side encompassing an edge portion of the outer panel 4. A sealing lip 33 is accommodated in this groove-tongue joint of function carrier 3 and outer panel 4, which fixes the groove-tongue joint and, additionally, covers the entire connection region which is visibly at the-outside.

1. A door assembly, in particular for use in a motor vehicle, having a window frame, a function carrier connectable with the window frame, which preferably integrally accommodates all door components, as well as an outer skin disposed on the outside of the function carrier and, if required, on the window frame.

2. The door assembly according to claim 1, characterized in that the outer skin does not substantially adopt a structure-supporting function.

3. The door assembly according to one of claims 1 and 2, characterized in that the door assembly does not comprise a door inner sheet metal.

4. The door assembly according to one of claims 1 and 3, characterized in that the function carrier consists of a preferably reinforced synthetic material preferably formed in an injection moulding process.

5. The door assembly according to one of claims 1 and 3, characterized in that the function carrier consists of a preferably reinforced synthetic material preferably formed in a resin injection moulding process.

6. The door assembly according to claim 4, characterized in that the function carrier comprises a thermoplastic matrix which is fiber-reinforced, if required.

7. The door assembly according to claim 5, characterized in that the function carrier comprises a duroplastic matrix which is fiber-reinforced, if required.

8. The door assembly according to one of claims 4 to 7, characterized in that reinforcement elements are arranged particularly in regions of the function carrier having higher loads, preferably long-fiber-reinforced PA, PET, PP or PE and, particularly preferred, endless-fiber-reinforced liners.

9. The door assembly according to one of claims 1 to 3, characterized in that the function carrier substantially consists of a light metal, preferably aluminium, preferably formed in a diecasting process.

10. The door assembly according to one of the preceding claims, characterized in that the function carrier is covered at least partially towards the vehicle interor with one or several door inner sheet panellings.

11. The door assembly according to one of the preceding claims, characterized in that the door component or door components comprise window lifter devices and/or loudspeaker systems and/or closing and opening systems and/or structure-reinforcing elements.

12. The door assembly according to one of the preceding claims, characterized in that the door assembly can be divided by the function carrier into a wet region and a dry region.

13. The door assembly according to one of the preceding claims, characterized in that the connection of function carrier and window frame is performed by screwing and/or riveting and/or welding and/or gluing.

14. The door assembly according to one of the claims 1 to 12, characterized in that the window frame is produced as one piece with the function carrier.

15. The door assembly according to one of the preceding claims, characterized in that the window frame is produced of a metal or a synthetic material, preferably of a fiber-reinforced synthetic material.

16. The door assembly according to one of the preceding claims, characterized in that at least one connection element is mounted on the window frame for the reinforcement of the hinge region and/or the locking region of the function carrier.

17. The door assembly according to one of the preceding claims, characterized in that the outer skin consists of metal or a synthetic material, preferably of glass-fiber-reinforced synthetic material.

18. A method for the production of a door assembly, in particular for the production of a door assembly according to claims 1 to 17, comprising the steps:
formation of a function carrier,
connection of the function carrier to a window frame,
accommodation of one or several door components in the function carrier, if required,
subsequent attachment of an outer skin, preferably an outer panel, to the function carrier.

19. The method according to claim 18, characterized in that the formation of the function carrier is preferably performed with a plurality of integrated door components in a casting process, preferably in an injection moulding process or in an injection embossing process.

20. The method according to claim 18, characterized in that the formation of the function carrier is preferably performed with a plurality of integrated door components in a resin injection process.

21. The method according to claims 18 to 20, characterized in that the outer skin was painted prior to the connection to the door assembly.

22. The method for connecting a door assembly, in particular a door assembly according to claims 1 to 17, to a function carrier, characterized in that the outer skin, preferably an outer panel, is connected on the outside to the function carrier.

23. The method according to claim 22, characterized in that the outer skin has laterally arranged embracing edges which engage with corresponding recesses of the function carrier.

24. The method according to one of claims 22 and 23, characterized in that the embracing edges are accommodated at least at two opposite sides of the outer skin.

25. The method according to one-of claims 22 to 24, characterized in that the connection between the outer skin and the function carrier is performed at least by means of two opposite groove-tongue joint regions.

26. The method according to claim 25, characterized in that the outer skin has a bend on a first side forming a groove, which embraces a region of the function carrier forming a spring, and a region forming a spring on another side, which engages a corresponding groove in the function carrier.

27. The method according to one of the preceding claims 22 to 26, characterized in that the groove-tongue connections additionally comprise sealing elements, preferably rubber lips.

28. The method according to claim 27, characterized in that the sealing elements substantially completely fill the groove-tongue connection as well as at least partially cover the regions of the outer skin and/or of the function carrier bordering the groove-tongue connection.
